(19) United States
(12) Patent Application Publication
(10) Pub. No.: US 2008/0277094 A1
(43) Pub. Date: Nov. 13, 2008

(54) MINIATURE HEAT-DISSIPATING FAN DEVICE

(75) Inventors: Wen-Yang Peng, Hsinchu County (TW); Tung-Chuan Wu, Hsinchu City (TW); Chan-Hsing Lo, Hsinchu County (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, Hsin-Chu (TW)

(21) Appl. No.: 11/834,162

(22) Filed: Aug. 6, 2007

(30) Foreign Application Priority Data
May 10, 2007 (TW) 096116579

(51) Int. Cl. F28F 7/00; H02K 1/27; H02K 11/00

(52) U.S. Cl. 165/80.3; 310/156.01; 310/68 B; 310/68 R

(57) ABSTRACT

A miniature heat-dissipating fan device is disclosed, which comprises: a frame; a shaft, pivotally connected to the frame; at least a planar coil, each being received in the frame and formed in a wave winding manner; at least a permanent magnet, each being connected to the shaft while being positioned about parallel to the at least one planar coil for enabling the generation of an alternating multipolar magnetic field; a plurality of blades, being disposed at positions corresponding to the at least one permanent magnet while centering around the axis of the shaft in a centrifugal manner; and at least a magnetically permeable back iron, disposed at a side of the at least one planar coil and being structured with a geometrical shape matching to the wave winding planar coil; wherein the plural blades are integrated with the at least one permanent magnet for enabling the same to rotate with the at least one permanent magnet synchronously. In an exemplary embodiment of the invention, the planar coil is structured with at least a hollowed area, each having a Hall-effect sensor embedded therein. With the aforesaid device, not only it can be structured as a thin-type device with improved convection efficiency, but also the magnetic flux density is increased.

### FIELD OF THE INVENTION

The present invention relates to a miniature heat-dissipating fan device, and more particularly, to a miniature heat-dissipating fan device not only being structured with a magnetically permeable back iron that is specifically shaped for matching with its planar coil, but also having its centrifugal blades to be integrally formed with its permanent magnet.

### BACKGROUND OF THE INVENTION

As the design of modern portable electronic device, e.g. notebook computer, third-generation cellular phone and personal digital assistant (PDA), is moving toward lighter, thinner and smaller while being integrated more powerful central processing unit (CPU), heat dissipation is becoming an urgent problem that required to be solved since an electronic device with poor heat dissipating efficiency may cause the whole system to become unstable, which is especially true for those future low-voltage high-current CPUs. Conventionally, the aforesaid heat dissipating problem is solved by arranging additional heat dissipating modules, such as those composed of fans, heat pipes and heat-dissipating fins, in the system. Thereby, heat generated by the operation of such portable electronic device is transmitted to the heat-dissipating fins through the heat pipe and then being dissipated into atmosphere while the operating of the fan is used for encouraging thermal convection and thus improving heat transfer efficiency.

Conventional heat dissipating fans mostly have their fan blades to be disposed around a sandwich type spindle motor and thus to be driven to rotate thereby, while the spindle motor is structured with a solenoid coil in a winding manner matching with the motor's multi-layered claw pole structure for generating a multipolar magnetic field. It is known that the magnetically permeable structure of the spindle motor must at least be comprised of three layers of claw pole structures and two layers of such winding coils so as to operate smoothly, and when it is integrated with a magnetically permeable back iron, such heat dissipating fans can be too bulky to be used in the modern slim-type electronic devices.

In some conventional heat-dissipating fans, the motors used thereby adopts micro planar coils. However, such motors are disadvantageous in that the resulting motor will have less amount of windings in its coil and thus the pole number is less; the manufacturing cost of such coil is comparatively higher; no magnetically permeable back iron capable of matching to such coil; and the motor will generate insufficient torque while it is used for driving a high-speed centrifugal impeller structure.

Therefore, it is required to have a highly efficient heat dissipating module, capable of being fitting inside the limited space of any modern slim-type electronic device for keeping such electronic device to operate at a stable temperature.

### SUMMARY OF THE INVENTION

The object of the present invention is to provide a miniature heat-dissipating fan device not only being structured with a magnetically permeable back iron that is specifically shaped for matching with its planar coil, but also having its centrifugal blades to be integrally formed with its permanent magnet.

To achieve the above object, the present invention provides a miniature heat-dissipating fan device, which comprises: a frame; a shaft, pivotally connected to the frame; at least a planar coil, each being received in the frame and formed in a wave winding manner; at least a permanent magnet, each being connected to the shaft while being positioned about parallel to the at least one planar coil for enabling the generation of an alternating multipolar magnetic field; a plurality of blades, being disposed in a manner that each is coupled to the at least one permanent magnet so as to rotate with the at least one permanent magnet synchronously; and at least a magnetically permeable back iron, each being disposed at a side of the at least one planar coil and each being structured with a geometrical shape matching to the wave winding planar coil.

In an exemplary embodiment of the invention, the plural blades are disposed centering around the axis of the shaft in a centrifugal manner while coupling to the at least one permanent magnet.

In an exemplary embodiment of the invention, each of the permanent magnet is shaped like a flat disc.

In an exemplary embodiment of the invention, each of the permanent magnet is made of a material containing ferrite or boron ferric aluminum, while it is integrally formed with the plural blades.

In an exemplary embodiment of the invention, the wave winding of each planar coil is in a wave shape selected from the group consisting of a square wave, a triangle wave and a sine wave.

In an exemplary embodiment of the invention, the miniature heat-dissipating fan device has two permanent magnets arranged therein while the plural blades are sandwiched between the two permanent magnets.

In an exemplary embodiment of the invention, there are two planar coils to be received inside the frame at positions respectively corresponding to the outer sides of the two permanent magnets opposite to those facing the blades.

In an exemplary embodiment of the invention, each planar coil is formed on an object selected from a flexible multilayer printed circuit board and a rigid printed circuit board.

In an exemplary embodiment of the invention, each planar coil is integrated with a Hall-effect sensor.

In an exemplary embodiment of the invention, each planar coil is structured with at least a hollowed area, each having a Hall-effect sensor embedded therein.

In an exemplary embodiment of the invention, each hollow area is arranged at a position between two neighboring wave crests of each wave-winding planar coil.

In an exemplary embodiment of the invention, each hollow area is structured to channel through the planar coil from edge to edge.

In an exemplary embodiment of the invention, the thickness of the Hall-effect sensor is no larger than that of the planar coil.

In an exemplary embodiment of the invention, the frame is comprised of a sleeve and a base in a manner that an accommodating space is formed by the enclosure of the sleeve and the base so as to be used for receiving the shaft, the at least one planar coil, the at least one permanent magnet, the plural blades and the magnetically permeable back iron.

In an exemplary embodiment of the invention, the sleeve is a cylinder having a plurality of radial-type outlets and at least an axial-type outlet.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is an exploded view of a miniature heat-dissipating fan device according to an exemplary embodiment of the invention.

FIG. 2 is a cross sectional view of a miniature heat-dissipating fan device according to an exemplary embodiment of the invention.

FIG. 3 is a top view showing an integrated structure of two permanent magnets and centrifugal blades according to an exemplary embodiment of the invention.

FIG. 4 is an A-A sectional view of FIG. 3.

FIG. 5 is a schematic diagram depicting a magnetically permeable back iron is in a geometrical shape matching to a planar coil according to the present invention.

FIG. 6 is a top view showing an integrated structure of a single permanent magnet and centrifugal blades according to another exemplary embodiment of the invention.

FIG. 7 is a B-B sectional view of FIG. 6.

FIG. 8 shows a Hall-effect sensor being fitted in a planar coil of the invention.

FIG. 9 is a cross sectional diagram showing a planar coil having a Hall-effect sensor embedded therein according to an exemplary embodiment of the invention.

FIG. 10 shows a miniature heat-dissipating fan device according to another exemplary embodiment of the invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

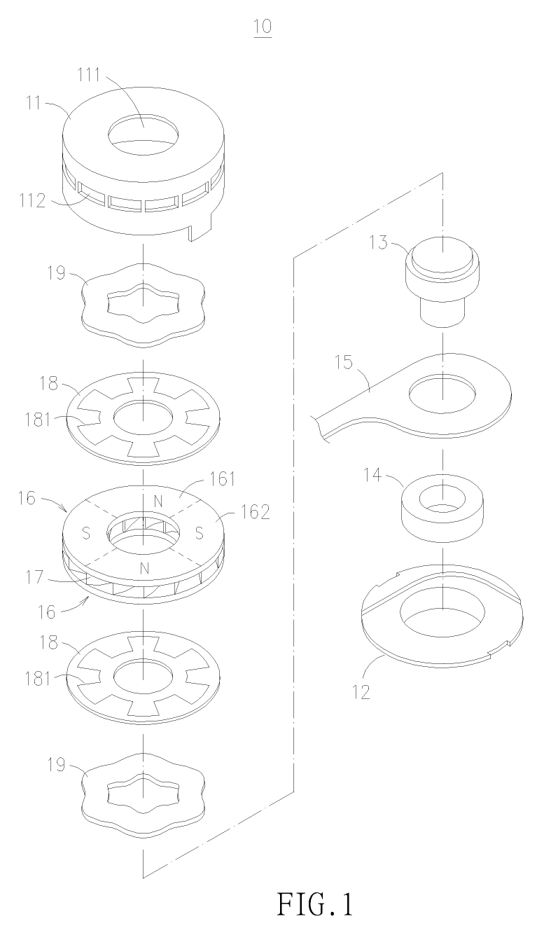

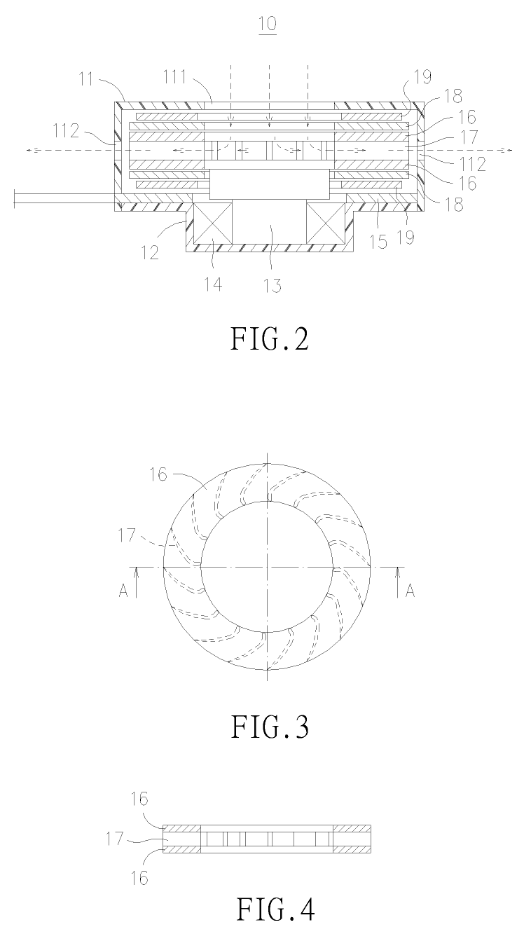

Please refer to FIG. 1 and FIG. 2, which show a miniature heat-dissipating fan device according to an exemplary embodiment of the invention. The miniature heat-dissipating fan device 10 is substantially a frame composed of a cylinder-like sleeve 11 and a disc-like base 12. As shown in FIG. 1, a shaft 13 is arranged in the frame in a manner that one axial end of the shaft 13 is pivotally connected to base 12 by a bearing 14. In an exemplary embodiment of the invention, the bearing 14 can be a micro-ball bearing, a journal bearing or a magnetic-suspension bearing. The journal bearing could be the self-lubricant type.

One characteristic of the miniature heat-dissipating fan device of the invention is that there are two permanent magnets 16, each shaped like a flat disc, to be disposed at positions neighboring to the center of the shaft 13, while each has a plurality of magnetic regions of alternating north and south polarities, referring as the north pole regions 161 and the south pole regions 162, and a plurality of blades 17 are sandwiched between the two permanent magnets 16. Each of the permanent magnet 16 is made of a material containing ferrite or boron ferric aluminum, while it is integrally formed with the plural blades 17. As shown in FIG. 2 to FIG. 4, the plural blades 17 are disposed centering around the axis of the shaft 13 in a centrifugal manner; and an inlet 111 and a plurality of radial-type outlets 112 are formed on the sleeve 11 in a manner that the inlet 111 aligned with the axis of the shaft 13 while the plural outlets are positioned corresponding to the plural blades 14 so that the hot air generated from an external electronic device can be sucked into the fan device 10 through the inlet 111 and then to be exhausted from the outlets 112 by the rotation of the blades 17.

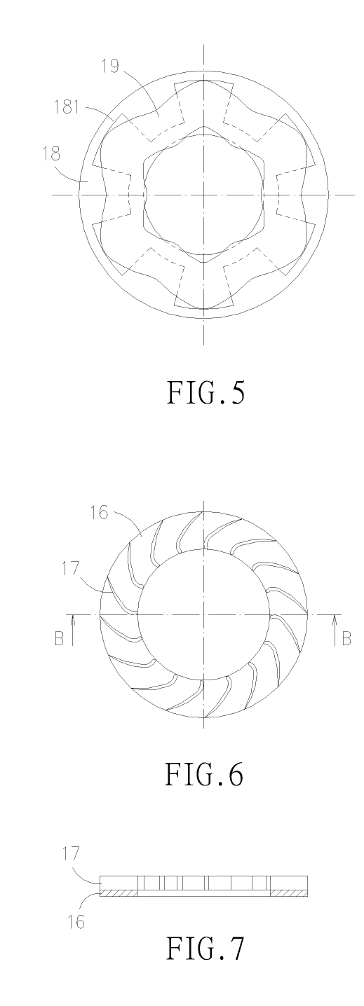

Moreover, there are two planar coils 18 to be received inside the frame at positions respectively corresponding to the outer sides of the two permanent magnets 16 opposite to those facing the blades 17 while enabling the two permanent magnets 16 to be positioned about parallel to the two planar coil 18. Each planar coil 18 can be formed on an object selected from a flexible multilayer printed circuit board and a rigid printed circuit board, while the winding 181 of each planar coils 18 is formed by a wave winding means, which can be formed in a shape selected from the group consisting of a square wave, a triangle wave and a sine wave. As shown in FIG. 5, the wave winding 181 is in a shape of a square wave. As there is a printed circuit board (PCB) 15 disposed on the base 12 which is electrically connected to the planar coils 18, an alternating multipolar magnetic filed can be induced by the planar coils 18 as seen as power of a two-phase direct current power source is fed to the planar coils 18 though the PCB 15 and controlled thereby, so that the alternating multipolar magnetic filed will affect the alternating north pole regions 161 and the south pole region 162 of each permanent magnet 18 in a manner that the two permanent magnets 18 are pushed to rotate for bringing the shaft 13 to rotate synchronously with the two permanent magnets 18 and thus bringing the plural blades 17 to rotate as well.

As the induction of the alternating multipolar magnetic filed by the feeding of power of a two-phase direct current power source is fed to the planar coils 18 though the control of the PCB 15 is disclosed in TW Pat. Appl. No. 94204332, it is provided and known to those skilled in the art so that it is not described further herein.

Another characteristic of the miniature heat-dissipating fan device of the invention is that there are magnetically permeable back irons 19 to be positioned respectively at positions corresponding to the outer sides of each planar coil 18, while each being structured with a geometrical shape matching to the wave winding 181 of the planar coil 18, as shown in FIG. 5, for concentrating the flow of magnetic lines to pass thorough the magnetically permeable back iron 19 so as to increase the effective magnetic flux density.

In another exemplary embodiment of the invention, the miniature heat-dissipating fan device can be structured with a single permanent magnet 16 and centrifugal blades 17, as that shown in FIG. 6 and FIG. 7. As there is one permanent magnet 16 less than the aforementioned embodiment and thus only one planar coil and one magnetically permeable back iron 19 is required, the overall thickness of the resulting miniature heat-dissipating fan device is greatly reduced.

It is emphasized that the frame formed by the sleeve 11 and the base is used for receiving and securing the stator structure composed of the planar coils 18 and the magnetically permeable back iron 19, but the mechanism for receiving and securing such stator structure is not limited thereby. That is, other mechanisms capable of receiving and securing such stator structure can be adopted by the miniature heat-dissipating fan device of the invention and used as the frame. For instance, the frame can be replaced by a simple strut structure. Similarly, although the aforesaid inlet and outlets formed on the sleeve 11 are all indispensable components for the miniature heat-dissipating fan device, their shapes and positions can be varied with respect to actual requirement or the formation of the frame.

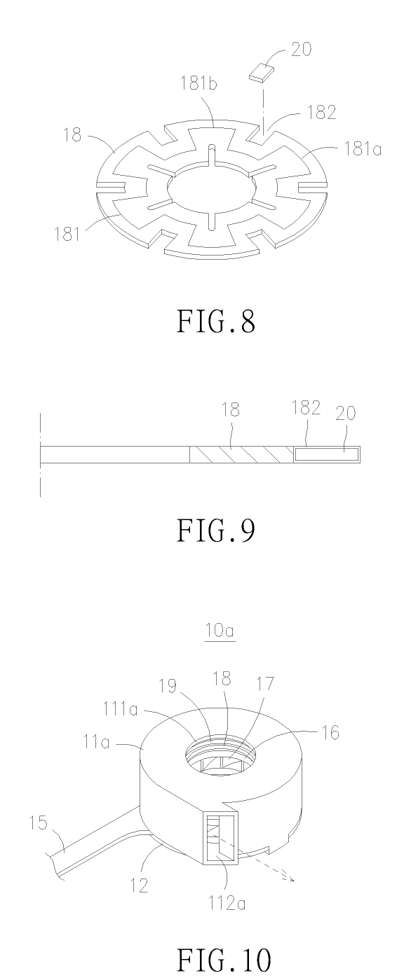

For brushless DC motor, Hall-effect sensor is usually being used for detecting magnet field variations and thus issuing a motor control signal so as to ensure the motor to operate stably. Please refer to FIG. 8 and FIG. 9, which show a Hall-effect sensor being fitted in a planar coil of the invention. As shown, the planar coil 18 is structured with a hollow area 183 to be used for receiving a Hall-effect sensor 20. In this exemplary embodiment, the hollow area 182 is formed at a position between two neighboring wave crests 181a, 181b of each wave-winding 181 of the planar coil 18. Moreover, the hollow area 182 is structured to channel through the planar coil 18 from edge to edge. It is noted that a Hall-effect sensor 20 of 0.55 mm thickness is adopted when the thickness of the planar coil 18 is about 0.6 mm so that the Hall-effect sensor 20 cab be embedded deeply into the planar coil 18, as shown in FIG. 9, by which, not only the disposition of the Hall-effect sensor 20 will not take up additional space, but also the overall thickness of the whole structure can be reduced. In addition, while coil is printing on a rigid or flexible multi-layered board, the process for embedding Hall-effect sensor can be incorporated with the printing of the coil, thereby, the overall manufacturing process can be simplified.

Please refer to FIG. 10, which shows a miniature heat-dissipating fan device according to another exemplary embodiment of the invention. In appearance, only a sleeve 11a, a base 12 and a circuit 15 can be seen. However, the miniature heat-dissipating fan device of FIG. 10 is also structured with a shaft 13, a bearing 14, a permanent magnet 16, centrifugal blades 17, planar coils 18 and a magnetically permeable back iron 18, which are similar to that illustrated in FIG. 1 and thus are not described further herein. The characteristic of the present embodiment shown in FIG. 10 is that: considering the relationship between amount of wind and the flow channel disposition, an axial-type outlet 112a is formed on the sleeve 11a, by which hot air generated by the centrifugal blades 17 can be concentrated and exhausted out of the outlet 112. With respect to the size of the outlet 112a as well as the location for disposing the same, they are dependent only upon the actual size of the miniature heat-dissipating fan device and thus are not limited by the embodiment shown in FIG. 10.

To sum up, as the miniature heat-dissipating fan device 10 of the invention, as that shown in FIG. 2, is designed with an integrated structure of permanent magnets 16 and centrifugal blades 17, not only its manufacturing process can be simplified while lowering the manufacturing cost, but also the overall thickness of the fan device is greatly reduce so as to be used in those slim-type electronic devices. In addition, as the plural blades 17 is arranged in a centrifugal manner that the axial-inflowing air flow, being sucked therein through the inlet 111, can be exhausted out of the fan device radially through the plural outlets 112, by which convection is enforced, but with enhanced efficiency. Moreover, by designing each magnetically permeable back iron 19 with a geometrical shape matching to the wave winding 181 of the planar coil 18, the effective magnetic flux density is increased.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A miniature heat-dissipating fan device, comprising:
a frame;
a shaft, pivotally connected to the frame;
at least a planar coil, each being received in the frame and formed in a wave winding manner;
at least a permanent magnet, each being connected to the shaft while being positioned about parallel to the at least one planar coil for enabling the generation of an alternating multipolar magnetic field;
a plurality of blades, being disposed in a manner that each is coupled to the at least one permanent magnet so as to rotate with the at least one permanent magnet synchronously; and
at least a magnetically permeable back iron, each being disposed at a side of the at least one planar coil and being structured with a geometrical shape matching to the wave winding planar coil.

2. The miniature heat-dissipating fan device of claim 1, wherein the plural blades are disposed centering around the axis of the shaft in a centrifugal manner while coupling to the at least one permanent magnet.

3. The miniature heat-dissipating fan device of claim 2, wherein each of the permanent magnet is shaped like a flat disc.

4. The miniature heat-dissipating fan device of claim 1, wherein each of the permanent magnet is made of a material containing ferrite or boron ferric aluminum, while it is integrally formed with the plural blades.

5. The miniature heat-dissipating fan device of claim 1, wherein the wave winding of each planar coil is in a wave shape selected from the group consisting of a square wave, a triangle wave and a sine wave.

6. The miniature heat-dissipating fan device of claim 1, wherein the miniature heat-dissipating fan device has two permanent magnets arranged therein while the plural blades are sandwiched between the two permanent magnets.

7. The miniature heat-dissipating fan device of claim 6, wherein there are two planar coils to be received inside the frame at positions respectively corresponding to the outer sides of the two permanent magnets opposite to those facing the blades.

8. The miniature heat-dissipating fan device of claim 1, wherein each planar coil is formed on an object selected from a flexible multilayer printed circuit board and a rigid printed circuit board.

9. The miniature heat-dissipating fan device of claim 8, wherein each planar coil is integrated with a Hall-effect sensor.

10. The miniature heat-dissipating fan device of claim 1, wherein each planar coil is structured with at least a hollowed area, each having a Hall-effect sensor embedded therein.

11. The miniature heat-dissipating fan device of claim 10, wherein each hollow area is arranged at a position between two neighboring wave crests of each wave-winding planar coil.

12. The miniature heat-dissipating fan device of claim 10, wherein each hollow area is structured to channel through the planar coil from edge to edge.

13. The miniature heat-dissipating fan device of claim 10, wherein the thickness of the Hall-effect sensor is no larger than that of the planar coil.

14. The miniature heat-dissipating fan device of claim 1, wherein the frame is comprised of a sleeve and a base in a manner that an accommodating space is formed by the enclosure of the sleeve and the base so as to be used for receiving the shaft, the at least one planar coil, the at least one permanent magnet, the plural blades and the magnetically permeable back iron.

15. The miniature heat-dissipating fan device of claim 14, wherein the sleeve is a cylinder having a plurality of radial-type outlets formed thereon.

16. The miniature heat-dissipating fan device of claim 14, wherein the sleeve is a cylinder having at least an axial-type outlet formed thereon.
